(19) United States
(12) Patent Application Publication
(10) Pub. No.: US 2010/0170258 A1
(43) Pub. Date: Jul. 8, 2010

(54) COOLING APPARATUS FOR COMBUSTOR TRANSITION PIECE

(75) Inventors: Ronald James CHILA, Greer, SC (US); Kevin Weston MCMAHAN, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/349,128

(22) Filed: Jan. 6, 2009

(51) Int. Cl. F02C 1/00

(52) U.S. Cl. 60/755

(57) ABSTRACT

Disclosed is an apparatus for cooling a single-piece duct includes at least one metal wrapper disposed at the transition piece located outboard of the transition piece. At least one support boss is located between the metal wrapper and the transition piece. The support boss, the metal wrapper and transition piece define at least one cooling flow channel for directing flow for cooling the transition piece. A related method of cooling a single-piece duct extending between a forward end of a combustor and a first stage of a turbine includes providing a plurality of flow direction devices radially between the single-piece duct and a metal wrapper extending at least partially around the single-piece duct; flowing cooling air into a space between the single-piece duct and the metal wrapper such that the plurality of flow direction devices guide the cooling air about a surface of the single-piece duct enclosed by the metal wrapper.

### BACKGROUND OF THE INVENTION

The subject invention relates to gas turbines. More particularly the subject invention relates to cooling of gas turbine components.

A typical gas turbine includes a plurality of combustors arranged in an annular array about a rotatable shaft. The combustors receive a combustible fuel from a fuel supply and compressed air from a compressor that is driven by the shaft. For each combustor, the fuel is combusted in the compressed air within a combustion chamber defined by a combustor liner to produce hot combustion gas. The combustion gas is expanded through a turbine to produce work for driving the shaft. The hot combustion gas is conveyed from the combustor liner to the turbine by a transition piece or duct. The hot combustion gas flowing through the transition duct subjects the duct structure to very high temperatures. Typically, cooling is provided to the transition duct by impingement flow directed from passing airflow through impingement holes at discreet locations in a sleeve enveloping the transition duct. A flexible joint between the liner and the transition piece requires additional cooling via compressor discharge air.

In commonly owned U.S. Pat. No. 7,082,766, there is disclosed a single-piece, combined combustor liner/transition piece that eliminates the flexible joint and thus also the need for targeted cooling of the joint. Nevertheless, there remains a need for more effective cooling of the single-piece, combined combustor liner/transition piece.

### BRIEF DESCRIPTION OF THE INVENTION

According to one aspect of the invention, a gas turbine combustor comprising: a single-piece duct adapted to extend between a forward end of a combustion chamber to a first turbine stage; a metal wrapper extending partially about the single-piece duct, and extending substantially a full axial length of the single-piece duct; and a plurality of support bosses disposed radially between the metal wrapper and the duct, the plurality of support bosses, the at least one metal wrapper, and the single-piece duct defining plural cooling flow paths for directing flow along and about the duct.

According to another aspect of the invention, a gas turbine combustor comprising: at least one combustion chamber having a forward end and an aft end; a duct connected at one end to the forward end of the combustion chamber and at an opposite end to a first stage of the turbine; at least one wrapper disposed at least partially about the single-piece duct; a plurality of generally airfoil shaped vanes disposed radially between the at least one wrapper and the single-piece duct.

According to yet another aspect of the invention, a method of cooling a single-piece duct extending between a forward end of a combustor and a first stage of a turbine comprising: providing a plurality of flow direction devices radially between the single-piece duct and a metal wrapper extending at least partially around the single-piece duct; flowing cooling air into a space between the single-piece duct and the metal wrapper such that said plurality of flow direction devices guide the cooling air about a surface of said single-piece duct enclosed by said metal wrapper.

The foregoing and other aspects, features, and advantages of the invention are apparent from the following detailed description taken in conjunction with the accompanying drawings identified below.

### BRIEF DESCRIPTION OF THE DRAWINGS

FIG. 1 is a partial cross-sectional view of a known gas turbine combustor arrangement;

FIG. 2 is a partial axial cross-sectional view illustrating an embodiment of an arrangement of transition pieces in the gas turbine of FIG. 1; and

FIG. 3 is a plan view of an embodiment of a cooling apparatus of a transition piece of the gas turbine of FIG. 1.

The detailed description explains embodiments of the invention, together with advantages and features, by way of example with reference to the drawings.

### DETAILED DESCRIPTION OF THE INVENTION

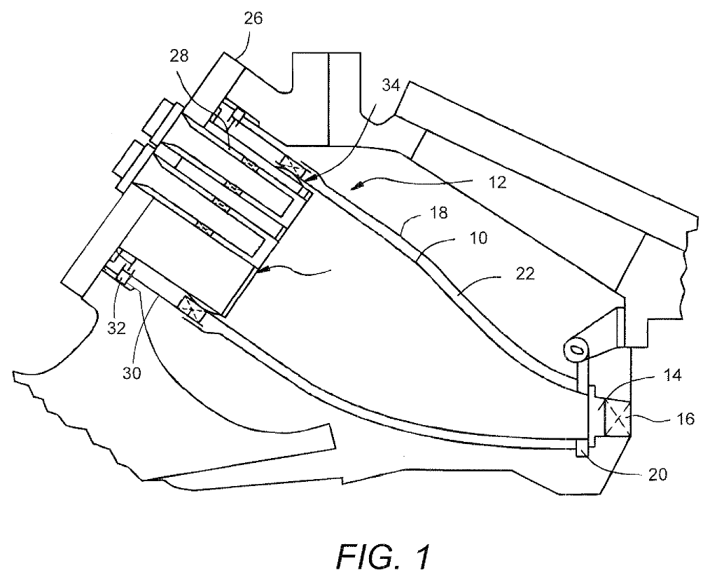

Referring to FIG. 1, there is illustrated a single-piece, combined combustor liner/transition piece (or single-piece duct) 10 which transitions directly from a circular combustor head-end (or forward end) 12 to a generally rectangular but arcuate sector 14 connected to the first stage of the turbine 16. The single-piece duct 10 may be formed from two halves or several components welded or joined together for ease of assembly or manufacture. Preferably, however, the duct would be cast as a single-piece. Likewise, a surrounding, single-piece flow sleeve 18 transitions directly from the circular combustor head-end 12 to an aft frame 20. The single-piece flow sleeve 18 may also be formed from two halves and welded or joined together for ease of assembly. The joint between the flow sleeve 18 and the aft frame 20 forms a substantially closed-end cooling annulus 22 located radially between the flow sleeve 18 and the single-piece duct 10.

Additional gas turbine combustor components include a circular cap 24, and an end cover 26 supporting a plurality of fuel nozzles 28. The single-piece duct 10 also supports a forward sleeve 30 that may be fixedly attached to the single-piece duct 10 through radial struts 32 cast or welded in place, or by other suitable means such as brazing or mechanical connection.

At its forward end, the single-piece duct 10 is supported by a conventional hula seal 34 attached to the cap 24, radially between the cap and the duct 10.

In use, compressor discharge air flows into and along the cooling annulus 22, formed by the flow sleeve 18 surrounding the single-piece duct 10, by means of impingement cooling holes, slots, or other openings formed in the flow sleeve 18, and that allow some portion of the compressor discharge air to also flow radially through the holes to impinge upon and thus cool the single-piece duct 10 and to then flow along the annulus 22 to the forward end of the combustor where the air is reverse-flowed into the combustion chamber.

The impingement holes may be arranged in various patterns, for example, in axially spaced, aligned or offset annular rows, etc. or even in a random array.

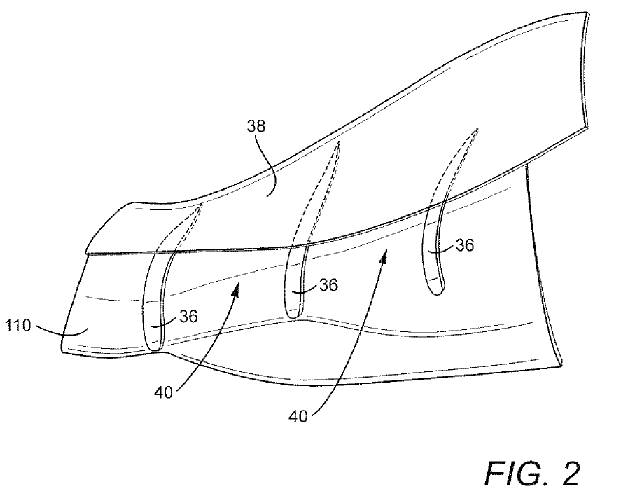

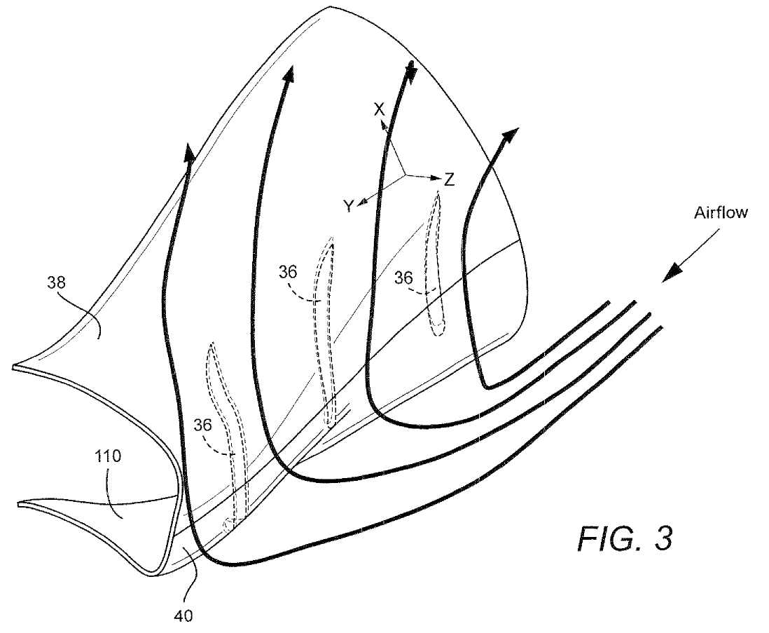

In an exemplary but nonlimiting implementation of the present invention, the flow sleeve 18 is eliminated in favor of an at least partially-surrounding sheet metal wrapper supported on the single piece duct 10. More specifically, and as shown in FIGS. 2 and 3, one or more support bosses 36 are disposed on the single-piece duct 110 and project radially away from the duct. The support bosses 36 are located so as to provide good support for a wrapper 38 which extends about at least a portion of the single-piece duct, and the support bosses 36 thus create one or more cooling flow paths 40 between the wrapper 38 and the duct 110. The support bosses 36 may be in the form of generally airfoil-shaped flow direction devices fastened to the single-piece duct 110 by any number of acceptable manufacturing techniques, such as casting or welding. The metal wrapper 38 does not need to encompass the entire single-piece duct 110, and preferably covers only the top (or outer) portion of the duct.

By arranging the airfoil-shaped bosses 36 about the single-piece duct 110 as shown in FIGS. 2 and 3 in a generally spiral fashion, the resulting flow paths 40 are also generally spirally-shaped so that the compressor discharge air is guided by the airfoil-shaped bosses 26 into the flow paths 40, causing the cooling air to flow across and about the outer surface of the single-piece duct 110 to thereby cool the duct. It will be appreciated that other support boss shapes may be used to redirect the discharge flow in other directions, and even patterns of bosses are contemplated by the present disclosure. For example, mirror-image patterns of bosses may be employed on opposite sides of the duct. It is preferable that the bosses do not, however, cross the longitudinal center line of the liner.

In the embodiment described above, the single outer wrapper 38 is disposed on the outboard side of the single-piece duct, noting again that several combustors are arranged in an annular array about the turbine rotor. In this embodiment, the inner portion of the single-piece duct 110 is cooled by substantially axially flowing compressor discharge air. In other words, part of the cooling air flows between adjacent single-piece ducts, and along the inner regions of the ducts, while flow in the outer regions of the ducts is redirected by the one or more airfoil-shaped devices supporting the plural wrappers 38 to cause the cooling discharge air to flow across and about the outer surface of the outer portion of the single-piece ducts, thus providing more effective cooling on the outer sides of the ducts. As indicated above, a second mirror-image wrapper (see the lower wrapper 40 in FIG. 3) may be used to enclose the inner portion of each of the single-piece ducts, with similar support bosses (or a continuation of the bosses on the upper or outer wrapper) and with a similar effect on the compressor discharge air flow.

In some embodiments, the wrapper may include one or more cooling holes which allow additional compressor discharge air to flow into the at least one cooling flow channel at desired locations to even further improve cooling effectiveness by adding an impingement cooling component. Additionally, the generally airfoil-shaped support bosses 36 may vary in size, shape, and placement to enhance the rate of heat transfer and to enhance a uniformity of distribution of the discharge flow to further improve cooling. For example, similarly oriented sets of bosses may be provided on opposite sides of the liner, either aligned or staggered. The bosses may be entirely hidden within the wrapper, or partially exposed as shown in FIG. 2. Further, in some embodiments, a leading edge of the wrapper may include, for example, a radiused edge integrally formed, or formed by bending the edge back on itself, which reduces a pressure drop of discharge flow entering the at least one cooling flow channel 40 thereby enhancing cooling efficiency of the cooling flow channels.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas turbine combustor comprising:
a single-piece duct adapted to extend between a forward end of a combustion chamber to a first turbine stage;
a metal wrapper extending partially about said single-piece duct, and extending substantially a full axial length of said single-piece duct; and
a plurality of support bosses disposed radially between said metal wrapper and said duct, said plurality of support bosses, said metal wrapper, and said single-piece duct defining plural cooling flow paths for directing flow along and about said duct.

2. The gas turbine combustor of claim 1 wherein said plurality of support bosses comprise substantially airfoil-shaped vanes.

3. The gas turbine combustor of claim 1 wherein each of said support bosses is arranged in an at least partial spiral form on a peripheral surface of said duct and engaged by said metal wrapper.

4. The gas turbine combustor of claim 1 wherein said metal wrapper comprises a pair of wrappers substantially completely surrounding said single-piece duct.

5. The gas turbine combustor of claim 1 wherein said plurality of support tosses is secured to one or both of said metal wrapper and said single-piece duct.

6. The gas turbine combustor of claim 5 wherein said plurality of support bosses are secured to said single-piece duct by welding or casting.

7. The gas turbine combustor of claim 1 wherein said metal wrapper is formed with at least one hole for providing additional flow into the at least one cooling flow channel.

8. The gas turbine combustor of claim 1 wherein said metal wrapper includes a radiused leading edge for reducing a pressure drop at an entrance to said at least one cooling flow channel.

9. The gas turbine combustor of claim 1 wherein said support bosses extend beyond the edges of said metal wrapper.

10. A gas turbine combustor comprising:
at least one combustion chamber having a forward end and an aft end;
a duct connected at one end to the forward end of the combustion chamber and at an opposite end to a first stage of the turbine;
at least one wrapper disposed at least partially about said single-piece duct;
a plurality of generally airfoil-shaped vanes disposed radially between said at least one wrapper and said single-piece duct.

11. The gas turbine combustor of claim 10 wherein said plurality of generally airfoil-shaped vanes extend beyond the edges of said at least one wrapper.

12. The gas turbine combustor of claim 10 wherein each of said generally airfoil-shaped vanes is arranged in a part-spiral form on a peripheral surface of said duct and engaged by said at least one wrapper.

13. The gas turbine combustor of claim 10 wherein said at least one wrapper comprises a pair of wrappers substantially completely surrounding said duct.

14. The gas turbine combustor of claim 13 wherein said plurality of generally airfoil-shaped vanes are each secured to said duct by welding or casting.

15. The gas turbine combustor of claim 10 wherein said at least one wrapper includes at least one cooling hole for providing additional flow between said duct and said wrapper.

16. The gas turbine combustor of claim 10 wherein said at least one wrapper includes a radiused leading edge for reducing pressure drop at an entrance to said at least one cooling flow channel.

17. A method of cooling a single-piece duct extending between a forward end of a combustor and a first stage of a turbine comprising:
providing a plurality of flow direction devices radially between the single-piece duct and a metal wrapper extending at least partially around said single-piece duct;
flowing cooling air into a space between said single-piece duct and said metal wrapper such that said plurality of flow direction devices guide the cooling air about a surface of said single-piece duct enclosed by said metal wrapper.

18. The method of claim 17 including inputting additional cooling air into said space via at least one hole disposed in said metal wrapper.

19. The method of claim 17 wherein the cooling air is discharged from a compressor.

20. The method of claim 17 wherein said metal wrapper encloses substantially a radially outer half of said single-piece duct.
